(19) United States
(12) Patent Application Publication
(10) Pub. No.: US 2020/0388088 A1
(43) Pub. Date: Dec. 10, 2020

(54) INFORMATION PROCESSING APPARATUS

(71) Applicant: NTT DOCOMO, INC., Tokyo (JP)

(72) Inventors: Hiroshi NAKAGAWA, Tokyo (JP); Kazuhiro YAMADA, Tokyo (JP); Youhei OONO, Tokyo (JP); Yuichiro SEGAWA, Toyko (JP)

(73) Assignee: NTT DOCOMO, INC., Tokyo (JP)

(21) Appl. No.: 16/767,289

(22) PCT Filed: Jan. 21, 2019
(86) PCT No.: PCT/JP2019/001697

§ 371 Date: May 27, 2020

(30) Foreign Application Priority Data
Jan. 26, 2018 (JP) 2018-011503

(51) Int. Cl. G07C 5/08; G07C 5/00; B64C 39/02; G05D 1/00; G06K 9/00; G06K 9/46

(52) U.S. Cl. CPC G07C 5/0808; G07C 5/008; B64C 39/024; G05D 1/0094; B64C 2201/14; G06K 9/4661; B64C 2201/042; B64C 2201/123; G06K 9/0063

(57) ABSTRACT

It is an object of the present invention to know the accuracy of the result of processing performed by an aircraft flying under a certain flying condition. Computation unit computes Accuracy of result of processing performed by aircraft flying under flight condition specified by specifying unit. Specifically, accuracy A is expressed by the function f of flight altitude of the aircraft.

A=f(h)

Battery life B (the time during which the aircraft can fly due to remaining power of battery) is expressed by function g of flight altitude h and flight speed v of aircraft.

B=g(h,v)

Note that the variables of function g may include area and shape of a processing target area (field), effective range Pu, a stop time at time of shooting (length of time stopped when temporarily stopped for shooting), number of times shooting is performed, and the like.

### TECHNICAL FIELD

The present invention relates to a technique for estimating the accuracy of a result obtained by performing processing using an aircraft.

### BACKGROUND

For example, Japanese Patent Application No. JP 2017-176115A discloses that a map in which a plurality of cells are arranged in a work area is generated, an area S is computed based on the map, and necessary work time is computed from the computed area S.

### SUMMARY OF INVENTION

For example, when an aircraft captures images of plants in a field and computes a Normalized Difference Vegetation Index (NDVI) from the spectral reflection characteristics of the plants, the computation accuracy of the NDVI varies depending on flight conditions such as the speed and altitude of the aircraft flying over the field. For example, the higher the flight speed of the aircraft, the worse the accuracy of the computed NDVI. Further, for example, the higher the flight altitude of the aircraft, the worse the accuracy of the computed NDVI.

In view of such a background, it is an object of the present invention to know the accuracy of a result of processing performed by an aircraft flying under a certain flight condition.

In order to solve the above issues, the present invention provides an information processing apparatus including; an obtaining unit configured to obtain a maximum flight time of an aircraft; a specifying unit configured to specify a flight condition applied when the aircraft performs processing on a processing target area over the obtained maximum flight time; and a computation unit configured to compute accuracy of a result of the processing performed by the aircraft flying under the specified flight condition.

The processing may be performed based on an image of the ground captured by the aircraft, and the specifying unit may specify an altitude of the aircraft as the flight condition based on a size of the processing target area.

The computation unit may change a size of an effective range in an image captured by the aircraft according to a condition.

The computation unit may change the size of the effective range according to a light amount at the time of image capturing or an image capturing timing.

The computation unit may correct the accuracy according to a light amount at the time of image capturing or an image capturing timing.

The information processing apparatus may further include a generation unit configured to generate, if the accuracy computed by the computation unit is lower than a lower limit of target accuracy set as a target, information regarding a size of the processing target area in which the processing is processed at the lower limit of the target accuracy.

The computation unit may compare an upper limit of accuracy obtained by performing calibration on the processing with target accuracy set as a target, and generate information corresponding to the comparison result.

According to the present invention, it is possible to know the accuracy of a result of processing performed by an aircraft flying under a certain flight condition.

### BRIEF DESCRIPTION OF DRAWINGS

FIG. 1 is a diagram showing an example of the configuration of flight control system 1, in accordance to the present invention.

FIG. 2 is a diagram showing an example of the outer appearance of aircraft 10, in accordance to the present invention.

FIG. 3 is a diagram showing a hardware configuration of aircraft 10, in accordance to the present invention.

FIG. 4 is a diagram showing a hardware configuration of server apparatus 20, in accordance to the present invention.

FIG. 5 is a diagram showing an example of a functional configuration of server apparatus 20, in accordance to the present invention.

FIG. 6 is a diagram illustrating an effective range of a captured image, in accordance to the present invention.

FIG. 7 is a diagram illustrating the significance of functions f and g, in accordance to the present invention.

FIG. 8 is a flowchart showing an example of an accuracy calculation operation of server apparatus 20, in accordance to the present invention.

### DETAILED DESCRIPTION

### Configuration

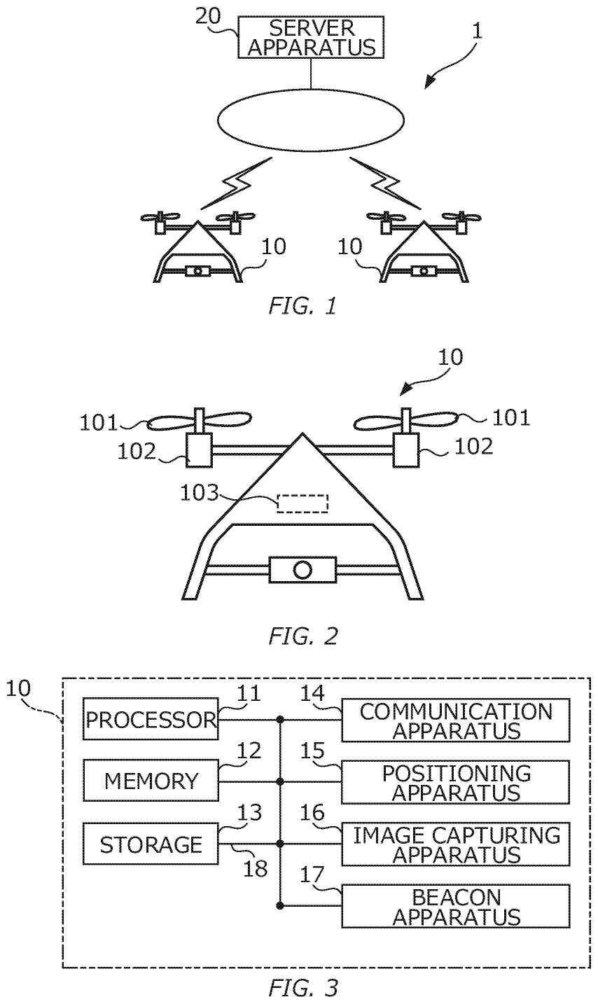

FIG. 1 is a diagram showing an example of the configuration of flight control system 1. Flight control system 1 is a system that controls the flight of aircraft 10. Flight control system 1 includes a plurality of aircraft 10 and server apparatus 20. Aircraft 10 and server apparatus 20 can communicate with each other via a network. Aircraft 10 performs, on a processing target area such as a field, a process for capturing images of plants in the field. Server apparatus 20 is an example of an information processing apparatus according to the present invention, and performs a process for computing a Normalized Difference Vegetation Index (NDVI) from the spectral reflection characteristics of plants in the processing target area using the image capturing result obtained by aircraft 10. The accuracy of the NDVI differs depending on flight conditions such as the speed and altitude of aircraft 10 flying over the field. Server apparatus 20 performs a process for computing the accuracy of the NDVI.

FIG. 2 is a diagram showing an example of the outer appearance of aircraft 10. Aircraft 10 is, for example, a so-called drone, and includes propellers 101, driving apparatuses 102, and battery 103.

Propellers 101 rotate around an axis. Aircraft 10 flies due to rotation by propellers 101. Driving apparatuses 102 rotate propellers 101 by applying power. Driving apparatuses 102 include, for example, motors and transmission mechanisms that transmit power of the motors to propellers 101. Battery 103 supplies power to each part of aircraft 10 including driving apparatuses 102.

FIG. 3 is a diagram showing a hardware configuration of aircraft 10. Aircraft 10 is physically configured as a computer apparatus including processor 11, memory 12, storage 13, communication apparatus 14, positioning apparatus 15, image capturing apparatus 16, beacon apparatus 17, bus 18, and the like. Note that in the following description, the term “apparatus” can be read as a circuit, a device, a unit, or the like.

Processor 11 controls, for example, an entire computer by operating an operating system. Processor 11 may be configured by a central processing apparatus (CPU: Central Processing Unit) that includes an interface to a peripheral apparatus, a control apparatus, an arithmetic apparatus, a register, and the like.

Also, processor 11 reads out a program (program code), a software module and data from storage 13 and/or communication apparatus 14 to memory 12, and executes various processes according to these. A program that causes a computer to execute at least a part of the operation of aircraft 10 is used as the program. Various processing executed in aircraft 10 may be executed by one processor 11, or may be executed simultaneously or sequentially by two or more processors 11. Processor 11 may be implemented with one or more chips. Note that the program may be transmitted from a network through a telecommunications line.

Memory 12 is a computer-readable recording medium, and for example, may be configured with at least one of a ROM (Read Only Memory), an EPROM (Erasable Programmable ROM), an EEPROM (Electrically Erasable Programmable ROM), and a RAM (Random Access Memory), and the like. Memory 12 may be called a register, a cache, a main memory (main storage apparatus), or the like. Memory 12 can save a program (program code), a software module, and the like that can be executed to implement the flight control method according to one embodiment of the present invention.

Storage 13 is a computer-readable recording medium, and for example, may be configured with at least one of an optical disk such as a CD-ROM (Compact Disc ROM), a hard disk drive, a flexible disk, a magneto-optical disk (for example, a compact disk, a digital versatile disk, or a Blu-ray (registered trademark) disk), a smart card, a flash memory (for example, a card, a stick, or a key drive), a floppy (registered trademark) disk, a magnetic strip, or the like. Storage 13 may be called an auxiliary storage apparatus.

Communication apparatus 14 is hardware (transmission and reception device) for performing communication between computers via a wired and/or wireless network, and is also referred to as, for example, a network device, a network controller, a network card, or a communication module.

Positioning apparatus 15 measures the three-dimensional position of aircraft 10. Positioning apparatus 15 is, for example, a GPS (Global Positioning System) receiver, and measures the current position of aircraft 10 based on GPS signals received from a plurality of satellites.

Image capturing apparatus 16 captures an image of the surroundings of aircraft 10. Image capturing apparatus 16 is, for example, a camera, and captures an image by forming an image on an image capturing element using an optical system. Image capturing apparatus 16 captures an image of a predetermined range below aircraft 10, for example.

Beacon apparatus 17 transmits a beacon signal of a predetermined frequency, and receives a beacon signal transmitted from another aircraft 10. The range of the beacon signal is a predetermined distance, such as 100m. The beacon signal includes aircraft identification information for identifying aircraft 10 that transmits the beacon signal. This aircraft identification information is used to prevent collision between aircrafts 10.

Apparatuses such as processor 11 and memory 12 described above are connected by bus 18 for communicating information. Bus 18 may be configured with a single bus, or may be configured with different buses between apparatuses.

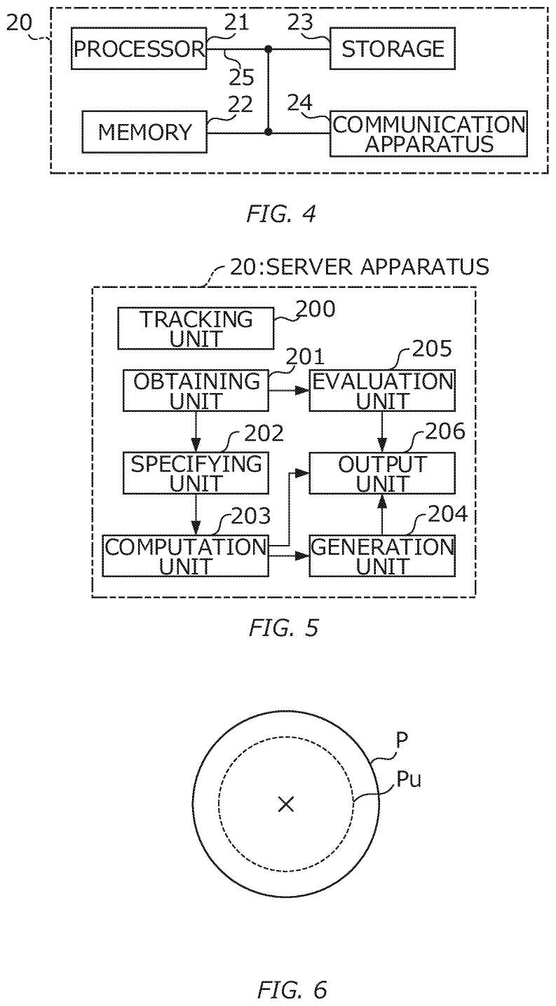

FIG. 4 is a diagram showing a hardware configuration of server apparatus 20. Server apparatus 20 is physically configured as a computer apparatus that includes processor 21, memory 22, storage 23, communication apparatus 24, bus 25, and the like. Processor 21, memory 22, storage 23, communication apparatus 24, and bus 25 are the same as the above-described processor 11, memory 12, storage 13, communication apparatus 14, and bus 18, and thus description thereof is omitted.

FIG. 5 is a diagram showing an example of a functional configuration of server apparatus 20. The respective functions of server apparatus 20 are realized, by reading predetermined software (a program) on hardware such as processor 21 and memory 22, by processor 21 performing an arithmetic operation to control communication by communication apparatus 24, and data reading and/or writing in memory 22 and storage 23.

In FIG. 5, tracking unit 200 records the aircraft identification information and flight status of aircraft 10 under the control of server apparatus 20. The flight status includes the position where aircraft 10 is flying and the date/time at that position. Tracking unit 200 records the position information and the date/time information transmitted from aircraft 10. In addition, tracking unit 200 determines whether or not the position information and the date/time information are within a flight plan planned in advance, and records the result of that determination.

Obtaining unit 201 obtains the maximum flight time of aircraft 10. Specifically, obtaining unit 201 obtains the maximum flight time by obtaining the remaining battery level of aircraft 10 and computing the maximum flight time from the obtained remaining battery level. In addition, obtaining unit 201 obtains the scheduled flight time designated by the operator or the like of aircraft 10 as the maximum flight time of aircraft 10. Also, obtaining unit 201 obtains image data indicating an image captured by aircraft 10.

Specifying unit 202 specifies the flight condition under which aircraft 10 is to perform processing on the processing target area over the maximum flight time obtained by obtaining unit 201. This process is, for example, a process of capturing an image of the ground (field) performed by aircraft 10. The flight condition is, for example, the altitude or speed at which aircraft 10 is to fly, and is specified by, for example, the operator of aircraft 10 or the like.

Evaluation unit 205 computes an NDVI (evaluation value) from the spectral reflection characteristics of the plants in the image, based on the image data obtained by obtaining unit 201.

Computation unit 203 computes the accuracy of the result (that is, the NDVI computed by evaluation unit 205) of the process performed by aircraft 10 flying under the flight condition specified by specifying unit 202. At this time, computation unit 203 computes the accuracy of the NDVI based on the size of the effective range in the captured image. Also, computation unit 203 changes the size of the effective range according to the conditions. More specifically, computation unit 203 determines the size of the effective range using the condition of the light amount at the time of image capturing. The larger the light amount at the time of image capturing, the larger the effective range, and the smaller the light amount at the time of image capturing, the smaller the effective range.

Here, the effective range in the captured image will be described. FIG. 6 is a diagram for explaining the effective range. A part of image captured range P is effective range Pu. Generally, the lens used when aircraft 10 captures an image for NDVI calculation is a fisheye lens. The image captured using the fisheye lens is a two dimensional circular image, and the NDVI is computed from the spectral reflection characteristics of the plants in the image. Because the calculation result of the NDVI differs depending on the elevation angle at the time of image capturing, the computation result at the end of the captured image is significantly changed. Accordingly, in the captured image, it is desirable to set a circular area of a predetermined range from the center of the image capture range as an effective range, and set the effective range as a computation target of the NDVI. When computing the NDVI of the field that is the processing target area, it is desirable to compute the NDVI from the spectral reflection characteristics of the plants in a range of a predetermined ratio (for example, 10%) of the size of the entire area. However, as described above, when the effective range in the captured image is different, the number of times image capturing processing is performed is also different. Specifically, when the effective range in the captured image is large (larger than a certain value), the number of times image capturing processing is performed for the processing target area is small, and when the effective range in the captured image is small (smaller than a certain value), the number of times image capturing processing is performed increases.

When the accuracy computed by computation unit 203 is lower than the lower limit of the target accuracy set as a target, generation unit 204 generates information regarding the size of the processing target area that can be processed at the lower limit of the target accuracy (for example, the ratio of the size of the processing target area that can be processed at the upper limit with respect to the original size of the entire processing target area). In this manner, when the entire range of the processing target area cannot be processed within the targeted required time, the processing completion degree of the processing target area can be estimated.

Output unit 206 outputs the accuracy computed by computation unit 203, the information generated by generation unit 204, or the NDVI computed by evaluation unit 205.

### Operation

Next, the operation of the present embodiment will be described. In the following description, when aircraft 10 is described as a subject of processing, specifically, by reading predetermined software (a program) on hardware such as processor 11 and memory 12, by processor 11 performing an arithmetic operation to control communication by communication apparatus 14, and data reading and/or writing in memory 12 and storage 13, processing is executed. The same applies to server apparatus 20.

FIG. 8 is a flowchart showing an example of an accuracy computation operation performed by the server apparatus 20. First, obtaining unit 201 obtains, from the server apparatus 20, battery life B and the flight condition of aircraft 10, and the size of the processing target area (step S11). Specifying unit 202 specifies the obtained flight condition (step S12).

Computation unit 203 computes the accuracy of the result (that is, the NDVI computed by evaluation unit 205) of the process performed by aircraft 10 flying under the flight condition specified by specifying unit 202 (step S13). Accuracy A is expressed by the function f of the flight altitude h of aircraft 10, as shown in the following equation:

A=f(h)

When aircraft 10 captures an image of the processing target area, as the flight altitude increases, an influence such as that of receiving reflected light from a wide ground range other than the area directly below aircraft 10 increases. Accordingly, the function f is designed so that accuracy A decreases as the flight altitude h of aircraft 10 increases.

Battery life B (that is, the time during which aircraft 10 can fly using the remaining power of battery 103) is expressed by the function g of the flight altitude h and the flight speed v of aircraft 10, as shown in the following equation:

B=g(h,v)

Here, because image capturing is performed with aircraft 10 in a stopped state, the flight speed v is the speed at which aircraft 10 moves between the image capturing positions. Also, the function g may include, as variables, the area and shape of the processing target area (field), effective range Pu, the stop time at the time of shooting (length of time stopped when temporarily stopped for shooting), the number of times shooting is performed, and the like.

That is to say, specifying unit 202 obtains the flight altitude h from battery life B using the function g, and computation unit 203 specifies accuracy A from the flight conditions including the flight altitude h and the like, using the function f.

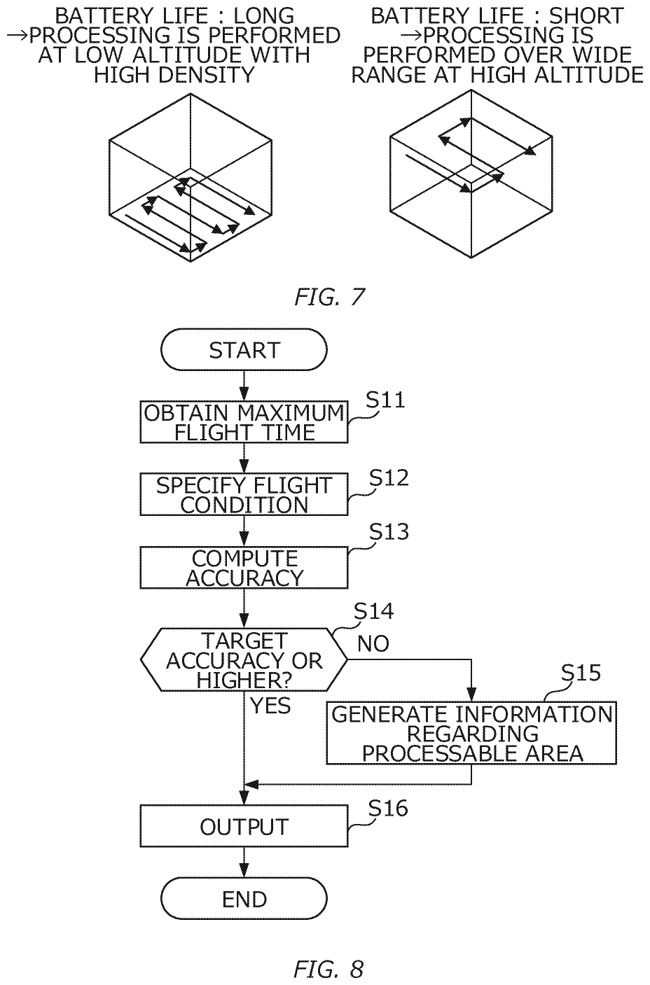

Here, the significance of the functions f and g will be described. First, a flight plan including various flight conditions is determined, based on battery life B and the size of the processing target area. Next, in order to compute the NDVI of the entire processing target area, the image capturing range that aircraft 10 is to cover with a single instance of image capturing is determined. Then, the flight altitude h required to perform the one instance of image capturing in this image capturing range is determined. At this time, above-described effective range Pu is used. Accordingly, as illustrated in FIG. 7, when life B is long, the image capturing processing is performed so that the flight altitude is low and the flight path with respect to the processing target area is highly dense. In this case, accuracy A is high. On the other hand, when battery life B is short, the image capturing processing is performed so that the flight altitude is high and the flight path with respect to the processing target area is low in density (that is, the processing range per unit section is large). In this case, accuracy A is low. In this manner, specifying unit 202 specifies the flight altitude h of aircraft 10 as a flight condition, based on the size of the processing target area.

If accuracy A computed by computation unit 203 is lower than the lower limit of the target accuracy At set as a target (NO in step S14), generation unit 204 generates information regarding the size of the processing target area that can be processed at the lower limit (step S15). Specifically, when the entire processing target area is S and the size of the processing target area that can be processed at the lower limit of the target accuracy At is Sd, as shown in the following equation:

Sd=S×A/At

Output unit 206 outputs size Sd (or, (Sd/S)×100(%)) of the processing target area that can be processed at the lower limit of accuracy A computed by computation unit 203 or the lower limit of target accuracy At (step S16).

According to the above embodiment, it is possible to know how accurately the NDVI has been computed, based on the processing performed by aircraft 10 flying under a certain flight condition.

### MODIFICATIONS

The present invention is not limited to the above-described embodiment. The embodiment described above may be modified as follows. Further, two or more of the following modifications may be combined.

### Modification 1

For example, because the sun elevation varies depending on the image capturing timing such as morning/afternoon, time zone, month, or season, and as a result, the light amount at the time of image capturing varies, computation unit 203 may correct the accuracy depending on the image capturing timing. Specifically, because the correction expression based on light amount L at the time of image capturing can be expressed by the function f(h) of time h, accuracy A is corrected by a mathematical expression: accuracy A×function f(h).

Also, computation unit 203 may correct the accuracy according to the light amount at the time of image capturing. Specifically, accuracy A is corrected by a mathematical expression: accuracy A×function f(L), using the function f(L) related to light amount L at the time of image capturing.

### Modification 2

Computation unit 203 may compare the lower limit of the accuracy when the calibration for the processing is performed with the target accuracy, and generate information corresponding to the comparison result. This makes it possible to determine whether the processing can be completed within a target time when the calibration is performed. Specifically, before the image capturing process, an object of a predetermined color such as a white board is captured to calibrate the image capturing apparatus. Through this calibration, the lower limit of accuracy when aircraft 10 performs processing with a predetermined target accuracy at a certain flight speed and flight altitude is obtained. Computation unit 203 may compare the lower limit of the accuracy when the calibration for the processing is performed with the accuracy set as the target, and generate information (for example, a ratio of the former to the latter) corresponding to the comparison result.

### Modification 3

As described above, because the light amount at the time of image capturing and the image capturing timing have a certain relationship, computation unit 203 may change effective range Pu according to the image capturing timing.

### Modification 4

In the present invention, the processing performed by aircraft is not limited to image capturing processing of a field or the like. In addition, each of the above-described mathematical expressions is merely an example, and addition or the like of a constant or a coefficient to the above-described mathematical expressions can be optionally performed.

### Other Modifications

The block diagrams used in the description of the above embodiment show blocks in functional units. These functional blocks (components) are realized by any combination of hardware and/or software. Further, the mechanism for realizing each functional block is not particularly limited. More specifically, each functional block may be realized by one physically and/or logically coupled apparatus, or two or more apparatuses physically and/or logically separated from each other directly and/or indirectly (for example, wired and/or wirelessly) may be coupled, and each functional block realized by a plurality of the apparatuses.

Further, at least some of the functions of server apparatus 20 may be implemented in aircraft 10. Similarly, at least some of the functions of aircraft 10 may be implemented in server apparatus 20.

The aspects/embodiments described in the present description may be employed to a system that uses LTE (Long Term Evolution), LTE-A (LTE-Advanced), SUPER3G, IMT-Advanced, 4G, 5G, FRA (Future Radio Access), W-CDMA (registered trademark), GSM (registered trademark), CDMA2000, UMB (Ultra Mobile Broadband), IEEE802.11 (Wi-Fi), IEEE802.16 (WiMAX), IEEE802.20, UWB (Ultra-WideBand), or Bluetooth (registered trademark), a system that uses another appropriate system, and/or a next-generation system that is an extension of any of the same.

The orders in the processing procedures, sequences, flowcharts, and the like of the aspects/embodiments described in the present description may be changed as long as no contradictions arise. For example, the methods explained in the present description show various step elements in an exemplified order, and are not limited to the specific order that is shown.

The aspects/embodiments described in the present description may also be used alone or in combination, or may also be switched when they are implemented. Furthermore, the notification of predetermined information (e.g., notification of “being X”) is not limited to being performed explicitly, and may also be performed implicitly (for example, notification of the predetermined information is not performed).

The terms “system” and “network” used in the present description can be used in an interchangeable manner.

The information and the parameters described in the present description may also be expressed by absolute values, relative values with respect to a predetermined value, or another type of corresponding information. For example, a radio resource may also be one indicated by an index.

The names used for the above-described parameters are in no way limiting. Furthermore, there may be a case where mathematical expressions and the like using these parameters are different from those explicitly disclosed in the present description. Various channels (such as, for example, a PUCCH and a PDCCH) and information elements (such as, for example, a TPC) can be identified by any suitable name, and thus various names assigned to these various channels and information elements are no way limiting.

The term “determining” used in the present description may include various types of operations. The term “determining” can include a case where judging, calculating, computing, processing, deriving, investigating, looking up (for example, looking up a table, a data base, or another data structure), or ascertaining is regarded as “determining”. Furthermore, the term “determining” can include a case where receiving (for example, receiving information), transmitting (for example, transmitting information), inputting, outputting, or accessing (for example, accessing data in the memory) is regarded as “determining”. Furthermore, the term “determining” can include a case where resolving, selecting, choosing, establishing, or comparing is regarded as “determining”. In other words, the term “determining” can include a case where some operation is regarded as “determining”.

The present invention may be provided as a flight control method or an information processing method that includes the processing steps performed in flight control system 1 and server apparatus 20. Also, the present invention may be provided as a program for execution in aircraft 10 or server apparatus 20. This program may be provided in an aspect of being recorded on a recording medium such as an optical disk, or may be provided in an aspect of being downloaded to a computer via a network such as the Internet and being installed in the computer to become usable, for example.

Software, instructions, and the like may also be transmitted/received via a transmission medium. For example, if software is transmitted from a web site, a server, or another remote source using a wired technology such as a coaxial cable, an optical fiber cable, a twisted-pair wire, or a digital subscriber line (DSL), and/or a wireless technology using infrared light, radio waves, microwaves, or the like, the definition of the transmission medium will include the wired technology and/or the wireless technology.

Information, signals, and the like described in the present description may also be expressed using any of various different technologies. For example, data, an instruction, a command, information, a signal, a bit, a symbol, a chip, and the like that may be mentioned throughout the entire description above may also be expressed by an electric voltage, an electric current, an electromagnetic wave, a magnetic field or a magnetic particle, an optical field or a photon, or an any combination thereof.

Note that the terms described in the present description and/or the terms needed for understanding the present description may also be replaced by terms that have the same or similar meaning. For example, a channel and/or a symbol may also be a signal. Furthermore, a signal may also be a message. Furthermore, a component carrier (CC) may also be referred to as a carrier frequency, a cell, or the like.

All references to elements that have been given names such as “first” and “second” in the present description do not overall limit the number of such elements or the orders thereof. Such names may be used in the present description as a convenient method for distinguishing between two or more elements. Accordingly, references to first and second elements are not intended to mean that only two elements can be employed, or that the first element is required to come before the second element in some sort of manner.

The “means” in the configurations of the above-described apparatuses may be replaced by “unit”, “circuit”, “device”, or the like.

The terms “including”, “comprising”, and other forms thereof are intended to be comprehensive as long as they are used in the present description or the claims, similar to the term “being provided with”. Furthermore, the term “or” used in the present description or the claims is intended not to be exclusive OR.

In the entirety of the present disclosure, when articles are added through translation, for example, as “a”, “an”, and “the” in English, these articles also denote the plural form unless it is clear otherwise from the context.

While the present invention has been described in detail, it would be obvious to those skilled in the art that the present invention is not limited to the embodiments explained in the present description. The present invention can be implemented as corrected and modified aspects without departing from the spirit and scope of the present invention that are defined by the description of the claims. Accordingly, the description in the present description aims to illustrate examples and is not intended to restrict the present invention in any way.

### REFERENCE SIGNS LIST

1. Flight control system
10. Aircraft
20. Server apparatus
21. Processor
22. Memory
23. Storage
24. Communication apparatus
25. Bus
200. Tracking unit
201. Obtaining unit
202. Specifying unit
203. Computation unit
204. Generation unit
205. Evaluation unit
206. Output unit

What is claimed is:

1.-7. (canceled)

8. An information processing apparatus comprising:
an obtaining unit configured to obtain a maximum flight time of an aircraft;
a specifying unit configured to specify a flight condition applied when the aircraft performs processing on a processing target area over the obtained maximum flight time; and
a computation unit configured to compute accuracy of a result of the processing performed by the aircraft flying under the specified flight condition.

9. The information processing apparatus according to claim 8, wherein
the processing is performed based on an image of the ground captured by the aircraft, and
the specifying unit specifies an altitude of the aircraft as the flight condition based on a size of the processing target area.

10. The information processing apparatus according to claim 8, wherein
the computation unit changes a size of an effective range in an image captured by the aircraft according to a condition.

11. The information processing apparatus according to claim 10, wherein
the computation unit changes the size of the effective range according to a light amount at the time of image capturing or an image capturing timing.

12. The information processing apparatus according to claim 9, wherein
the computation unit corrects the accuracy according to a light amount at the time of image capturing or an image capturing timing.

13. The information processing apparatus according to claim 8, further comprising
a generation unit configured to generate, if the accuracy computed by the computation unit is lower than a lower limit of target accuracy set as a target, information regarding a size of the processing target area in which the processing is performed at the lower limit of the target accuracy.

14. The information processing apparatus according to claim 8, wherein
the computation unit compares an upper limit of accuracy obtained by performing calibration on the processing with target accuracy set as a target, and generates information corresponding to the comparison result.
